(19) United States
(12) Patent Application Publication
(10) Pub. No.: US 2025/0192278 A1
(43) Pub. Date: Jun. 12, 2025

(54) FLOW GUIDING ASSEMBLY AND BATTERY FORMATION EQUIPMENT HAVING THE SAME

(71) Applicant: Chroma Ate Inc., Taoyuan City (TW)

(72) Inventors: Hao-Jhang Huang, Taoyuan City (TW); Ying-Chi Chen, Taoyuan City (TW); Wen-Chuan Chang, Taoyuan City (TW); Chuan-Tse Lin, Taoyuan city (TW)

(21) Appl. No.: 18/945,020

(22) Filed: Nov. 12, 2024

(30) Foreign Application Priority Data
Dec. 8, 2023 (TW) 112147823

(51) Int. Cl. H01M 10/6566; H01M 10/04; H01M 10/613; H01M 10/627; H01M 10/6563; H01M 10/663

(52) U.S. Cl. CPC H01M 10/6566; H01M 10/04; H01M 10/613; H01M 10/627; H01M 10/6563; H01M 10/663

(57) ABSTRACT

A flow guiding cover assembly is adapted to be disposed in a cabinet, and between an air conditioning device and a carrier tray. The carrier tray carries at least one battery pack. The flow guiding cover assembly includes an air intake cover and at least one air outlet cover. The air intake cover is adapted to be disposed at one side of the air conditioning device, and is provided for a cooling airflow outputted by the air conditioning device to flow therethrough. The at least one air outlet cover is connected to the air intake cover and is adapted for discharging the cooling airflow to a top portion of the at least one battery pack.

### CROSS-REFERENCE TO RELATED APPLICATIONS

This application claims priority to Taiwanese Invention patent application No. 112147823, filed on Dec. 8, 2023, the entire disclosure of which is incorporated by reference herein.

### FIELD

The present disclosure relates to a flow guiding cover assembly and a battery formation equipment having the same, and more particularly to a flow guiding cover assembly and a battery formation equipment that guide cooling airflow for dissipating heat.

### BACKGROUND

In a conventional battery formation equipment, each of a plurality of battery sets is connected to two spaced-apart charge and discharge sets to charge and discharge the battery set. During charging and discharging processes of the battery sets, a large amount of heat is generated by the charge and discharge sets and the battery sets. Thus, heat of the conventional battery formation equipment needs to be dissipated.

An existing heat dissipation approach involves disposing a fan above the charge and discharge sets to guide a cooling airflow to flow downward, such that the cooling airflow first flows through the charge and discharge sets and then flows toward the battery sets. However, since the cooling airflow passes between the charge and discharge sets first, heat generated by the charge and discharge sets would flow downwardly together with the cooling airflow. In addition, at the same time, heat generated by the charge and discharge sets is transferred to the cooling airflow, which increases the temperature of the cooling airflow flowing toward the battery sets, thereby leading to a relatively poor heat dissipation effect for the battery sets.

### SUMMARY

Therefore, an object of the disclosure is to provide a flow guiding cover assembly and a battery formation equipment having the same that can alleviate at least one of the drawbacks of the prior art.

According to an aspect of the disclosure, a flow guiding cover assembly is adapted to be disposed in a cabinet and between an air conditioning device and a carrier tray. The carrier tray carries at least one battery pack. The flow guiding cover assembly includes an air intake cover and at least one air outlet cover. The air intake cover is adapted to be disposed at one side of the air conditioning device, and is provided for a cooling airflow outputted by the air conditioning device to flow therethrough. The at least one air outlet cover is connected to the air intake cover and is adapted for discharging the cooling airflow to a top portion of the at least one battery pack.

According to another aspect of the present disclosure, a battery formation equipment includes a cabinet, an air conditioning device, a carrier tray, at least one charge and discharge device, and the flow guiding cover assembly described above. The air conditioning device is disposed at an outer side of the cabinet. The carrier tray is disposed in the cabinet and is adapted to carry at least one battery pack. The at least one charge and discharge device is disposed in the cabinet and above the carrier tray. The at least one charge and discharge device includes two charge and discharge sets that are spaced-apart from each other, and that are adapted to be electrically connected to the at least one battery pack. The at least one air outlet cover of the flow guiding cover assembly is disposed between the charge and discharge sets.

According to still another aspect of the present disclosure, a battery formation equipment includes a cabinet, an air conditioning device, a carrier tray, a plurality of charge and discharge devices, and a flow guiding cover assembly. The air conditioning device is disposed at an outer side of the cabinet. The carrier tray is disposed in the cabinet and is adapted to carry a plurality of battery packs that are spaced apart from each other. The plurality of charge and discharge devices are disposed in the cabinet and above the carrier tray. Each of the plurality of charge and discharge devices includes two charge and discharge sets that are spaced-apart from each other and that are adapted to be electrically connected to a respectively one of the plurality of battery packs. The flow guiding cover assembly is disposed in the cabinet and between the air conditioning device and the carrier tray, and includes an air intake cover and a plurality of air outlet covers. The air intake cover is disposed at one side of the air conditioning device, and is provided for a cooling airflow outputted by the air conditioning device to flow therethrough. The plurality of air outlet covers are connected to the air intake cover. Each of the plurality of air outlet covers is disposed between the charge and discharge sets of a respective one of the plurality of charge and discharge devices, and is adapted to be disposed above a respective one of the plurality of battery packs for discharging the cooling airflow to a top portion of the respective one of the plurality of battery packs.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of a first embodiment of a battery formation equipment according to the present disclosure.

FIG. 2 is a fragmentary sectional view of the first embodiment, illustrating configuration of a cabinet, an air conditioning device, a carrier mechanism, a plurality of charge and discharge devices, and a flow guiding cover assembly of the battery formation equipment.

FIG. 3 is a schematic perspective view of the first embodiment, illustrating the configuration of the carrier mechanism, the charge and discharge devices and the flow guiding cover assembly, the cabinet and the air conditioning device shown in FIG. 2 being omitted.

FIG. 4 is a partly exploded perspective view of the charge and discharge devices and the flow guiding cover assembly and a plurality of battery packs.

FIG. 5 is a perspective view of the flow guiding cover assembly of the first embodiment.

FIG. 6 is a partly exploded perspective view of the flow guiding cover assembly of the first embodiment.

FIG. 7 is a fragmentary perspective view of the flow guiding cover assembly of the first embodiment.

FIG. 8 is a fragmentary sectional view of the first embodiment, illustrating the battery packs being carried by a carrier tray of the carrier mechanism and electrically and respectively connected to the charge and discharge devices, and flowing directions of a cooling airflow outputted by the air conditioning device to the flow guiding cover assembly to dissipate heat generated by the battery packs.

FIG. 9 is a perspective view of a flow guiding cover assembly of a second embodiment of the battery formation equipment according to the present disclosure.

FIG. 10 is a fragmentary sectional view of the second embodiment.

FIG. 11 is a perspective view of a flow guiding cover assembly of a third embodiment of the battery formation equipment according to the present disclosure.

FIG. 12 is a fragmentary sectional view of the third embodiment.

FIG. 13 is a fragmentary sectional view of a fourth embodiment of the battery formation equipment according to the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

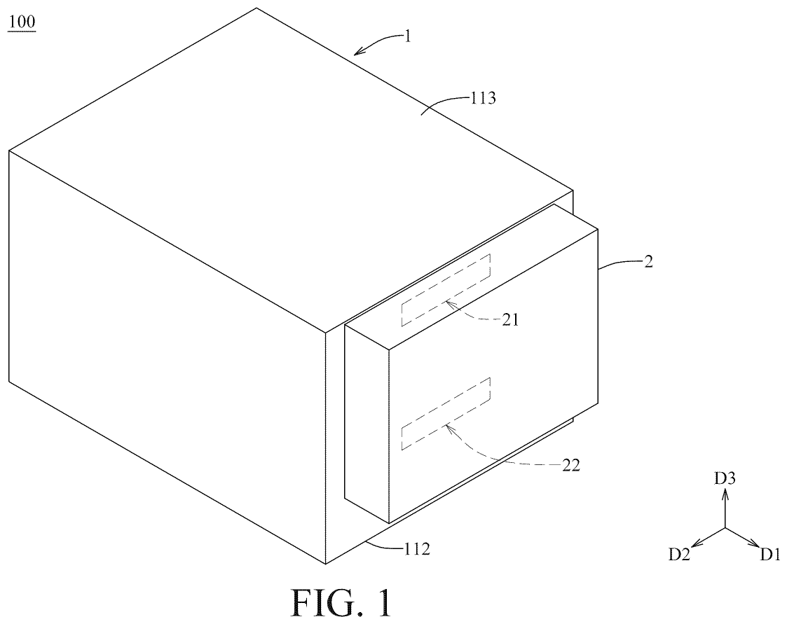

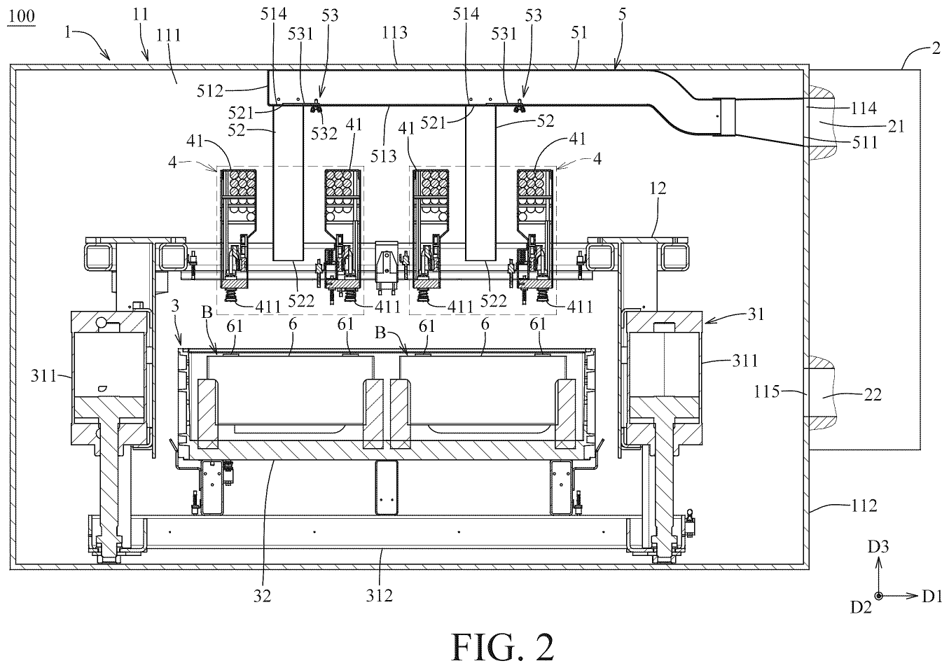

Referring to FIGS. 1 and 2, a first embodiment of a battery formation equipment 100 according to the present disclosure includes a cabinet 1, an air conditioning device 2, a carrier mechanism 3, a plurality of charge and discharge devices 4, and a flow guiding cover assembly 5.

The cabinet 1 includes a cabinet body 11 and a cabinet frame 12. The cabinet body 11 is formed with a chamber 111. The cabinet body 11 has a side wall 112, and a top wall 113 connected to a top portion of the side wall 112. The side wall 112 is formed with a first vent 114 disposed adjacent to the top wall 113, and a second vent 115 spaced apart from and disposed under the first vent 114 in a vertical direction (D3). The cabinet frame 12 is disposed in the chamber 111 of the cabinet body 11. The air conditioning device 2 is disposed at an outer side of the side wall 112, and is formed with an air conditioner outlet 21, and an air conditioner inlet 22 spaced apart from and disposed under the air conditioner outlet 21 in the vertical direction (D3). The air conditioner outlet 21 and the air conditioner inlet 22 are in fluid communication respectively with the first vent 114 and the second vent 115. A cooling airflow outputted by the air conditioning device 2 is discharged through the air conditioner outlet 21 to the first vent 114. The air conditioner inlet 22 draws air in the chamber 111 to flow outwardly therethrough via the second vent 115.

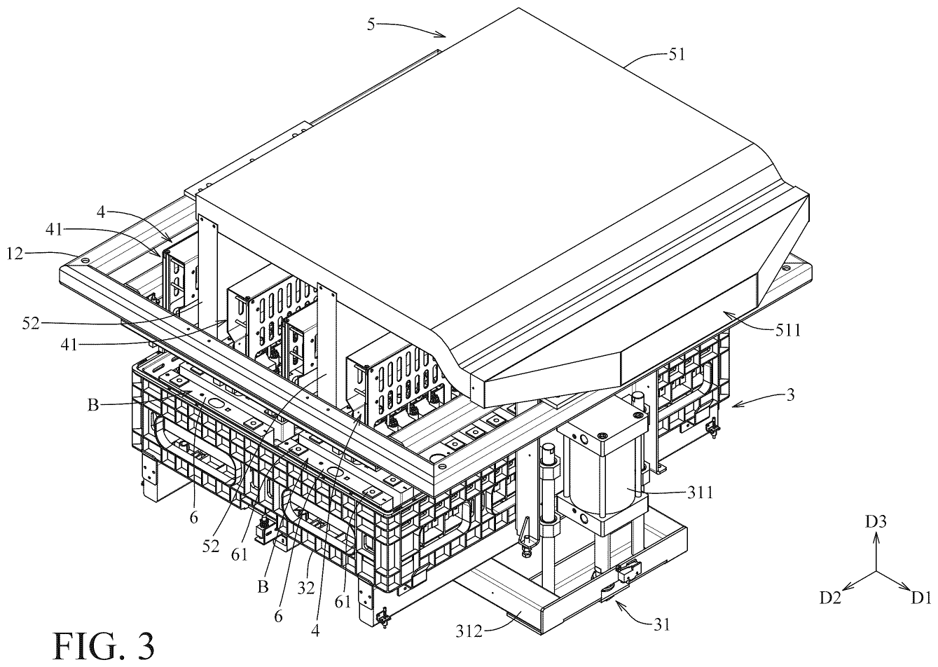

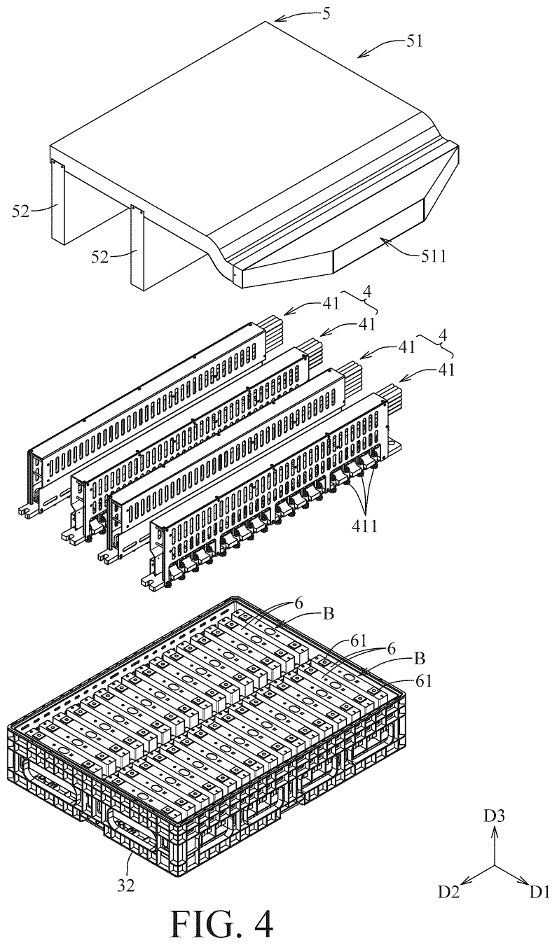

Referring to FIGS. 2 to 4, the carrier mechanism 3 is disposed in the chamber 111 of the cabinet 1, and includes a lifting module 31 and a carrier tray 32. The lifting module 31 includes two air cylinders 311 and a lifting frame 312. The air cylinders 311 are disposed on the cabinet frame 12 and are spaced apart from each other in a first horizontal direction (D1) perpendicular to the vertical direction (D3). The lifting frame 312 is connected to bottom portions of the air cylinders 311 and is driven by the air cylinders 311 to move upward and downward. The carrier tray 32 is disposed on the lifting frame 312 and is driven by the lifting frame 312 to move upwardly and downwardly. The carrier tray 32 is adapted to carry a plurality of battery packs (B). The battery packs (B) are spaced apart from each other in the first horizontal direction (D1). Each of the battery packs (B) is elongated in a second horizontal direction (D2) perpendicular to the first horizontal direction (D1) and the vertical direction (D3), and includes a plurality of batteries 6 that are spaced apart from each other in the second horizontal direction (D2). A top portion of each of the batteries 6 has two electrodes 61 spaced apart from each other in the first horizontal direction (D1).

The charge and discharge devices 4 are disposed in the chamber 111 of the cabinet 1, are disposed above the carrier tray 32, and are spaced apart from each other in the first horizontal direction (D1). Each of the charge and discharge devices 4 includes two charge and discharge sets 41 disposed on the cabinet frame 12 and spaced apart from each other in the first horizontal direction (D1). A bottom portion of each of the charge and discharge sets 41 has a plurality of probes 411 that are spaced apart from each other in the second horizontal direction (D2). The probes 411 of the charge and discharge sets 41 of each of the charge and discharge devices 4 are electrically connected to the electrodes 61 of the batteries 6 of a respective one of the battery packs (B).

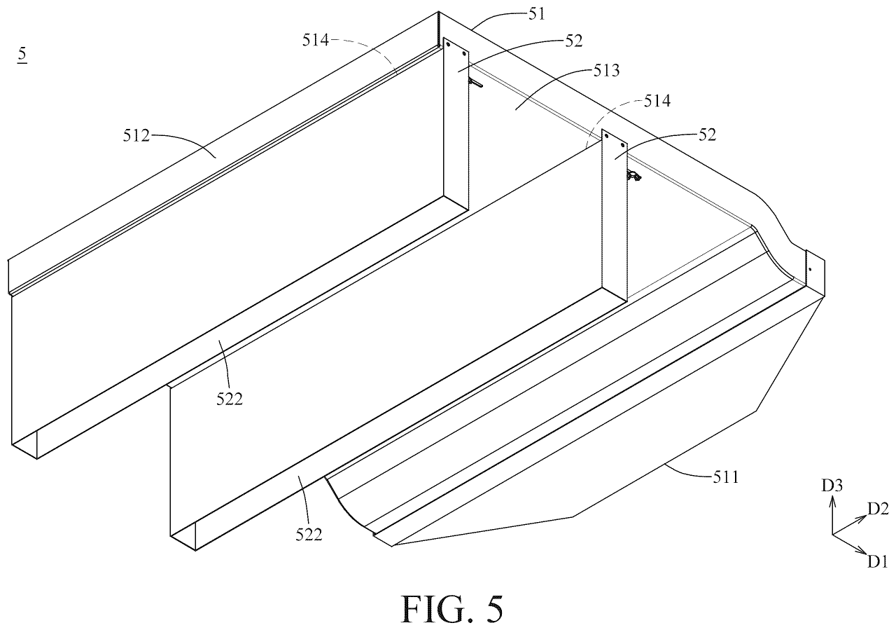

Referring to FIGS. 2 to 5, the flow guiding cover assembly 5 is disposed in the chamber 111 of the cabinet 1 and between the air conditioning device 2 and the carrier tray 32. The flow guiding cover assembly 5 includes an air intake cover 51 and a plurality of air outlet covers 52. The air intake cover 51 is disposed at one side of the air conditioning device 2 and is provided for the cooling airflow outputted by the air conditioning device 2 to flow therethrough. The air outlet covers 52 are connected to the air intake cover 51. Each of the air outlet covers 52 is disposed between the charge and discharge sets 41 of a respective one of the charge and discharge devices 4 and above the carrier tray 32, and is adapted to be disposed above a respective one of the battery packs (B) for discharging the cooling airflow to a top portion of the respective one of the battery packs (B), thereby directly dissipating heat from the battery packs (B).

The air intake cover 51 is flat in shape and extends in the first horizontal direction (D1). The air intake cover 51 is connected fixedly to the cabinet body 11 by fastening means (not shown). The air intake cover 51 is formed with an air intake port 511. The air intake port 511 is in fluid communication with the first vent 114 of the cabinet body 11 and is in fluid communication with the air conditioner outlet 21 of the air conditioning device 2 via the first vent 114, such that the cooling airflow outputted by the air conditioning device 2 may flow into the air intake cover 51 via the first vent 114 and the air intake port 511.

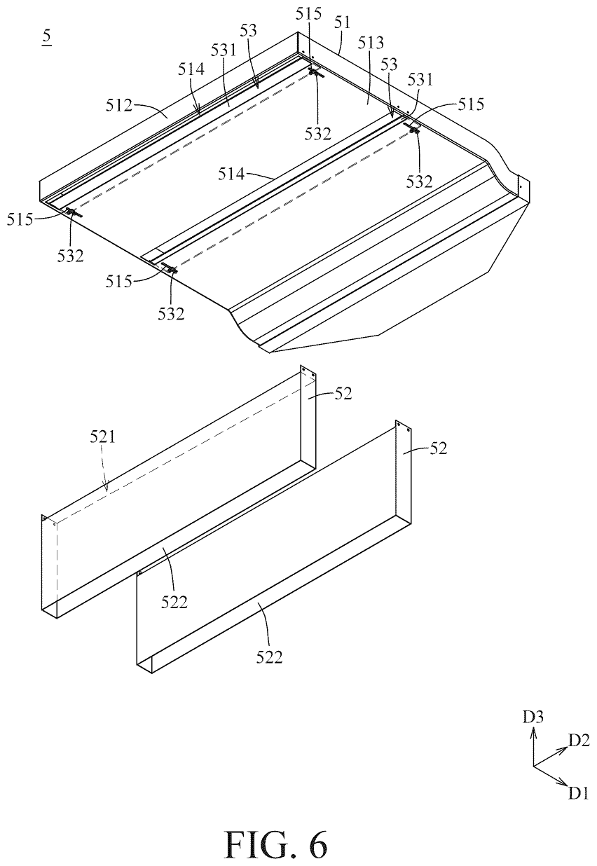

With reference to FIGS. 2, 5 and 6, the air intake cover 51 has an end wall 512 opposite to and spaced apart from the air intake port 511 in the first horizontal direction (D1), and a base wall 513 disposed between the air intake port 511 and the end wall 512. The base wall 513 is formed with a plurality of exhaust ports 514 spaced-apart from each other in the first horizontal direction (D1). Each of the exhaust ports 514 is elongated in the second horizontal direction (D2) for discharge of the cooling airflow.

The air outlet covers 52 are disposed on the base wall 513 of the air intake cover 51 and are spaced apart from each other in the first horizontal direction (D1). Each of the air outlet covers 52 is upright and extends in the vertical direction (D3). Each of the air outlet covers 52 is formed with an upper air inlet 521 and a lower air outlet 522 disposed under the upper air inlet 521. The upper air inlet 521 of each of the air outlet covers 52 is elongated in the second horizontal direction (D2), and is in fluid communication with a respective one of the exhaust ports 514 such that the cooling airflow discharged from the respective one of exhaust ports 514 flows through the upper air inlet 521 into the air outlet cover 52. The lower air outlet 522 of each of the air outlet covers 52 is elongated in the second horizontal direction (D2), and is disposed proximate to the probes 411 of the charge and discharge sets 41 of the respective one of the charge and discharge devices 4. The lower air outlet 522 of each of the air outlet covers 52 faces downward, and faces the top portion of the respective one of the battery packs (B) for discharging the cooling airflow to the top portion of the respective one of the battery packs (B).

Referring to FIGS. 2, 6 and 7, the flow guiding cover assembly 5 further includes a plurality of door assemblies 53. Each of the door assemblies 53 includes a gate 531 disposed in the air intake cover 51. The gate 531 is elongated in second horizontal direction (D2), is configured as a plate, and is operable to cover at least a portion of a respective one of the exhaust ports 514. The gate 531 of each of the door assemblies 53 is operated such that a covering degree of the gate 531 covering the respective one of the exhaust ports 514 is adjusted, and an opening size of the respective one of the exhaust ports 514 is in negative correlation with the covering degree. Thus, an amount of the cooling airflow flowing through each of the exhaust ports 514 may be adjusted by moving the gate 531 of the respective one of the door assemblies 53.

Specifically, the base wall 513 of the air intake cover 51 is further formed with a plurality of pairs of elongated guide grooves 515 that are respectively proximate to the exhaust ports 514. The elongated guide grooves 515 of each pair of the elongated guide grooves 515 are spaced apart from each other in the second horizontal direction (D2). Each of the elongated guide grooves 515 is elongated in the first horizontal direction (D1). Each of the door assemblies 53 further includes two adjustment screws 532 respectively extending through and movable along the elongated guide grooves 515 of a respective one pair of the elongated guide grooves 515. For each of the door assemblies 53, the adjustment screws 532 are threadedly and fixedly connected to the gate 531, detachably fasten the gate 531 to the base wall 513, and are operable to drive the gate 531 to move relative to the base wall 513 through movements of the adjustment screws 532 respectively along the elongated guide grooves 515 of the respective one pair of the elongated guide grooves 515 when the gate 531 is detached from the base wall 513.

When a user intends to adjust the opening size of each of the exhaust ports 514, the adjustment screws 532 of the respective one of the door assemblies 53 are first loosened to detach the gate 531 from the base wall 513. Subsequently, for each of the door assemblies 53, the adjustment screws 532 are respectively pushed along the elongated guide grooves 515 to move the gate 531 relative to the base wall 513 to thereby adjust an opening size of the respective one of the exhaust ports 514. For each of the door assemblies 53, after the gate 531 is moved to a desired position, the adjustment screws 532 are tightened to fasten the gate 531 to the base wall 513 and thus an adjustment operation is completed. Since the adjustment screws 532 of each of the door assemblies 53 that have a relatively simple structure may drive movement of the gate 531 and may detachably fasten the gate 531 to the base wall 513, an overall structure of the door assembly 53 is relatively simple, thereby reducing a manufacturing cost of the flow guiding cover assembly 5.

In the first embodiment, the covering degrees of the gates 531 of the door assemblies 53 gradually decrease from the end wall 512 toward the air intake port 511, and the opening sizes of the exhaust ports 514 gradually increase from the end wall 512 toward the air intake port 511 such that amounts of the cooling airflow respectively flowing through the exhaust ports 514 gradually decrease from the air intake port 511 toward the end wall 512. That is to say, one of the exhaust ports 514 that is closest to the end wall 512 has the smallest opening degree, and another one of the exhaust ports 514 that is closest to the air intake port 511 has the largest opening degree.

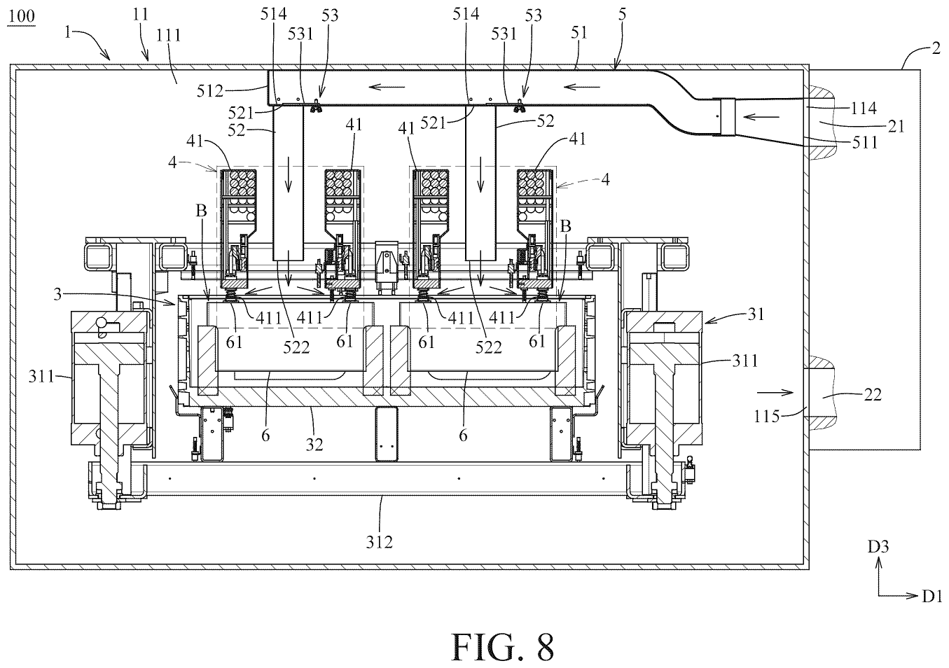

Referring to FIG. 8, when the battery formation equipment 100 performs charge and discharge processes on the battery packs (B), the air cylinders 311 are operated to drive the carrier tray 32 and the battery packs (B) to rise in the vertical direction (D3) via the lifting frame 312, so the carrier tray 32 is lifted to a lifted position shown in FIG. 8. At this position, the probes 411 of the charge and discharge sets 41 of each of the charge and discharge devices 4 are in contact with and electrically connected to the electrodes 61 of the batteries 6 of the respective one of the battery packs (B). In this way, the charge and discharge sets 41 of each of the charge and discharge devices 4 may charge and discharge the respective one of the battery packs (B).

During the charge and discharge processes performed by the charge and discharge sets 41 of the charge and discharge devices 4 on the battery packs (B), the cooling airflow outputted by the air conditioning device 2 is discharged through the air conditioner outlet 21 to the first vent 114 and enters the air intake cover 51 via the first vent 114 and the air intake port 511. Since the air intake port 511 of the air intake cover 51 is in fluid communication with the air conditioner outlet 21 of the air conditioning device 2 via the first vent 114, all of the cooling airflow outputted by the air conditioner outlet 21 directly flows into the air intake cover 51 via the air intake port 511, thereby preventing the cooling airflow from mixing with the air in the chamber 111 which may adversely affect a temperature of the cooling air flow. Thus, a temperature of the cooling airflow flows into the flow guiding cover assembly 5 may be kept within a certain temperature range.

Since the air intake cover 51 is flat and extends in the first horizontal direction (D1), the cooling airflow flows from the air intake port 511 along the air intake cover 51 toward the end wall 512 as indicated by the arrows shown in FIG. 8. When the cooling airflow flows to one of the exhaust ports 514 (i.e., the right one of the exhaust ports 514 in FIG. 8), a portion of the cooling airflow diverts and flows into the one of the exhaust ports 514, and then flows through the upper air inlet 521 of the respective one of the air outlet covers 52 into the respective one of the air outlet covers 52 while the remaining portion of the cooling airflow continues to flow toward the end wall 512. Similarly, when the remaining cooling airflow flows to a next one of the exhaust ports 514 (i.e., the left one of the exhaust ports 514 in FIG. 8), another portion of the cooling airflow diverts and flows into the next one of the exhaust ports 514 and then flows through the upper air inlet 521 of the respective one of the air outlet covers 52 into the respective one of the air outlet covers 52. By virtue of the structures of the opening sizes of the exhaust ports 514 that gradually increase from the end wall 512 toward the air intake port 511, the amounts of the cooling airflow respectively flowing through the exhaust ports 514 gradually decrease from the air intake port 511 toward the end wall 512. In this way, the amounts of cooling airflow flowing through the exhaust ports 514 are relatively uniform, so the cooling airflow is distributed evenly to the air outlet covers 52.

In the following descriptions, since the air outlet covers 52 have identical structures, the charge and discharge devices 4 have identical structures, and the battery packs (B) have identical structures, only one of the air outlet covers 52, the respective one of the charge and discharge devices 4, and the respective one of the battery packs (B) will be describe for the sake of brevity. Since the air outlet cover 52 is disposed between the charge and discharge sets 41 of the charge and discharge device 4, the cooling airflow may be discharged toward a middle part of the top portions of the batteries 6 of the battery pack (B). By virtue of the structure of the lower air outlet 522 that is elongated in the second horizontal direction (D2) in which the battery pack (B) extends, the cooling airflow discharged by the lower air outlet 522 may flow to the top portion of the batteries 6 of the battery pack (B). When the cooling airflow is discharged from the lower air outlet 522 and hits the middle part of the top portion of the batteries 6 of the battery pack (B), the cooling airflow is split into two flows that respectively flow to left and right sides toward the charge and discharge sets 41, as indicated by the arrows shown in FIG. 8. In this way, the cooling airflow may quickly dissipate heat from the electrodes 61 of the batteries 6 and the probes 411 so as to dissipate heat from the battery pack (B) and the charge and discharge device 4.

By virtue of the air conditioner inlet 22 of the air conditioning device 2 that continuously draws air in the chamber 111 outwardly via the second vent 115, the cooling airflow that absorbs heat in the chamber 111 and that turns into a heated airflow may be effectively discharged. In addition, through a continuous supply of the cooling airflow outputted by the air conditioner outlet 21 of the air conditioning device 2 to the flow guiding cover assembly 5, the cooling airflow continuously dissipates heat from the electrodes 61 of the batteries 6 and the probes 411 that are in contact therewith, thereby ensuring that the temperature of the batteries 6 is kept within a predetermined temperature range during the charge and discharge processes.

Since the air outlet cover 52 is disposed between the charge and discharge sets 41 of the charge and discharge device 4, the cooling airflow in the air outlet cover 52 does not pass the charge and discharge sets 41 and is not directly affected by the heat generated by the charge and discharge sets 41 before flowing out of the outlet cover 52, thereby preventing an increase in temperature thereof. Moreover, since the lower air outlet 522 of the air outlet cover 52 faces downwardly and faces the top portion of the battery packs (B) and is adjacent to the probes 411 of the charge and discharge sets 41, the cooling airflow may quickly flow to the top portion of the battery pack (B) after being discharged through the lower air outlet 522. In this way, the heat in the chamber 111 may be taken away relatively fast and effectively by the cooling airflow, and the air in the chamber 111 does not affect the temperature of the cooling airflow. By virtue of the abovementioned design of the air outlet cover 52, heat dissipation performed by the battery formation equipment 100 on the battery pack (B) and the charge and discharge device 4 is relatively good.

It should be noted that, in the first embodiment, the number of battery packs (B), the number of charge and discharge devices 4, the number of the exhaust ports 514, the number of the air outlet covers 52, and the number of the door assemblies 53 are two, but are not limited hereto. In other embodiments, the battery formation equipment 100 of the present disclosure may be modified and are described in the following.

In one embodiment, the number of battery packs (B), the number of charge and discharge devices 4, the number of the exhaust ports 514, the number of the air outlet covers 52, and the number of the door assemblies 53 are more than two.

In another embodiment, the number of battery pack (B), the number of charge and discharge device 4, the number of the exhaust port 514, and the number of the air outlet cover 52 is one, and the door assemblies 53 are omitted.

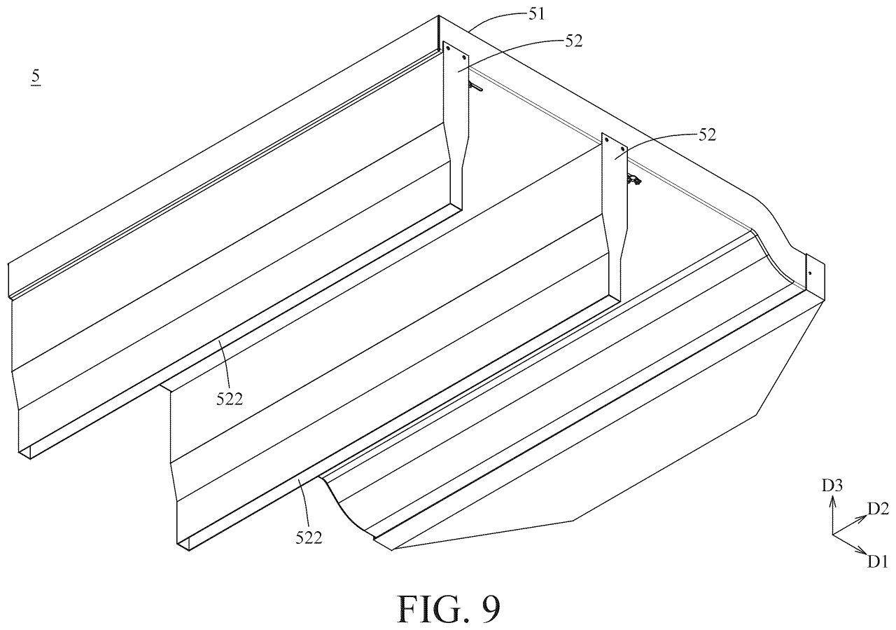

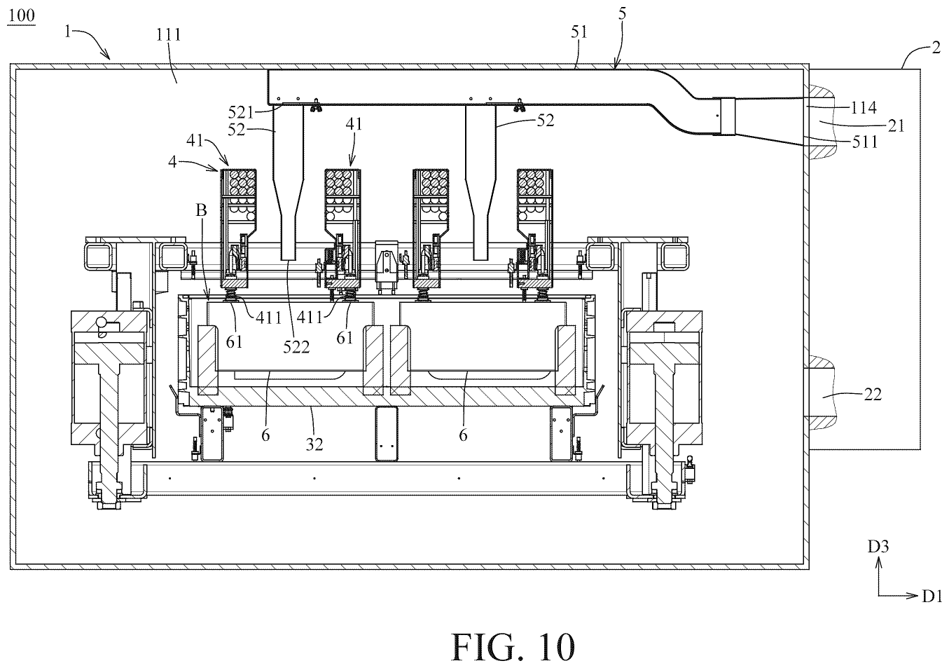

Referring to FIGS. 9 and 10, a second embodiment of the battery formation equipment 100 according to the present disclosure is shown. An overall structure of the second embodiment is similar to the first embodiment, and the difference between the first embodiment and the second embodiment resides in the structures of the air outlet covers 52 of the flow guiding cover assembly 5.

For each of the air outlet covers 52, the lower air outlet 522 is smaller than the upper air inlet 521, such that a flow rate of the cooling airflow discharged from the lower air outlet 522 is increased, and thus the cooling airflow may flow more quickly than that flows in the first embodiment to the top portion of the respective one of the battery packs (B) after being discharged via the lower air outlet 522.

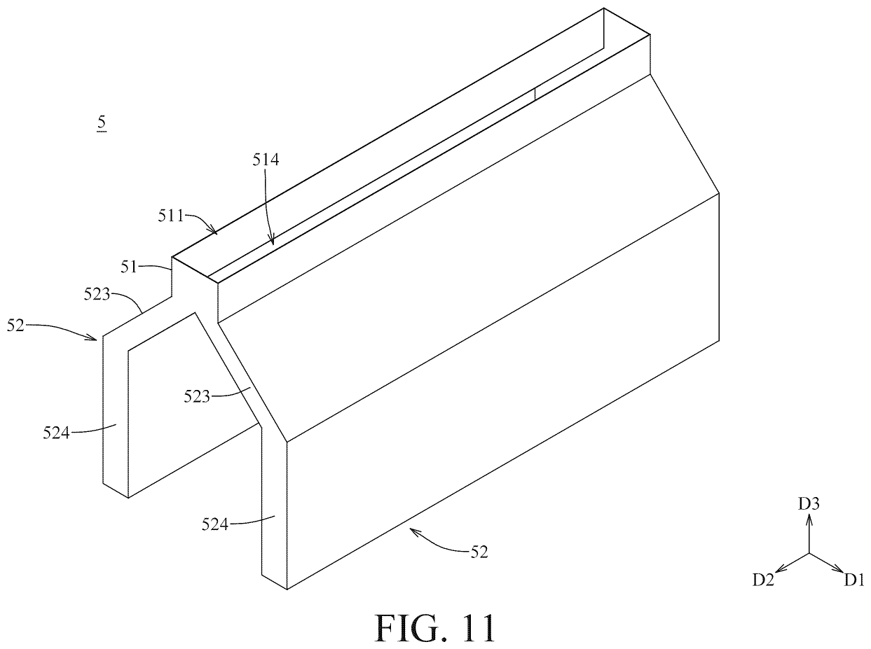

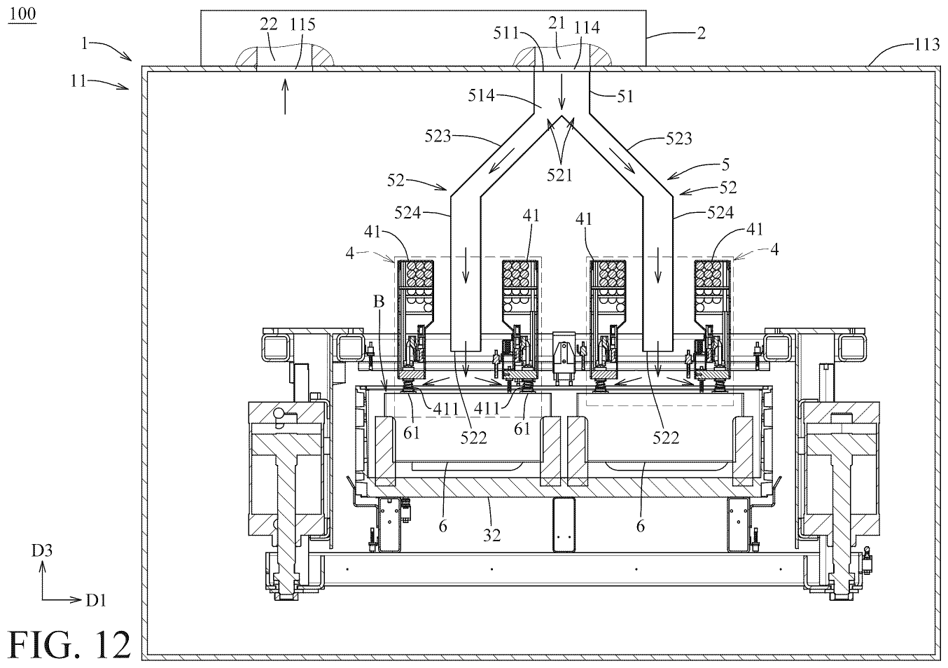

Referring to FIGS. 11 and 12, a third embodiment of the battery formation equipment 100 according to the present disclosure is similar to the first embodiment, and the differences therebetween reside in the configurations of the air conditioning device 2 and the structure of the flow guiding cover assembly 5.

In the third embodiment, the first vent 114 and the second vent 115 of the cabinet 1 are formed in the top wall 113, and the second vent 115 is spaced apart from the first vent 114 in the first horizontal direction (D1). The air conditioning device 2 is mounted on an outer side of the top wall 113. The air conditioner outlet 21 and the air conditioner inlet 22 of the air conditioning device 2 are respectively in fluid communication with the first vent 114 and the second vent 115 of the cabinet 1.

The air intake cover 51 of the flow guiding cover assembly 5 is upright and extends in the vertical direction (D3). The air intake port 511 of the air intake cover 51 faces upward, and is in fluid communication with the first vent 114, and is in fluid communication with the air conditioner outlet 21 via the first vent 114. In the third embodiment, the number of the exhaust port 514 of the air intake cover 51 is one, and the exhaust port 514 is spaced apart from and disposed under the air intake port 511 and faces downward. In this embodiment, the number of the air outlet covers 52 is two, and each of the air outlet covers 52 includes a manifold section 523 connected to a bottom portion of the air intake cover 51, and a vertical section 524 connected to a bottom portion of the manifold section 523. The manifold sections 523 of the air outlet covers 52 are connected to each other, respectively have the upper air inlets 521 that are in fluid communication with the exhaust port 514, and extend downwardly and inclinedly from the bottom portion of the air intake cover 51 and away from each other. The exhaust port 514 is in fluid communication equally with the upper air inlets 521 of the manifold sections 523 of the air outlet covers 52. The vertical sections 524 of the air outlet covers 52 are spaced apart from each other in the first horizontal direction (D1). For each of the air outlet covers 52, the vertical section 524 extends in the vertical direction (D3), has the lower air outlet 522, and is disposed between the charge and discharge sets 41 of the respective one of the charge and discharge devices 4.

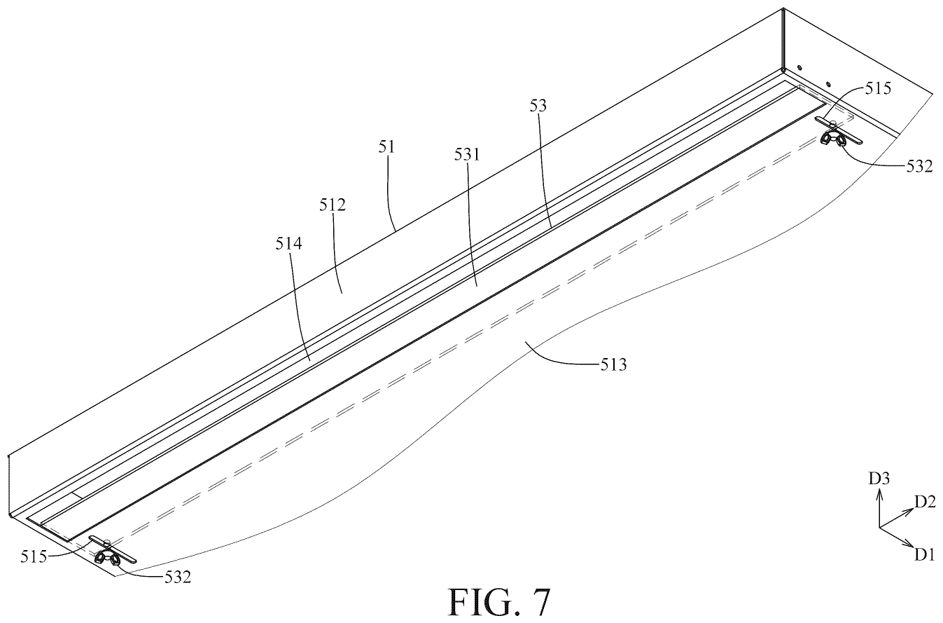

By virtue of the exhaust port 514 that is in fluid communication equally with the upper air inlets 521 of the manifold sections 523 of the air outlet covers 52, the cooling airflow flowing from the air intake cover 51 is distributed evenly to the air outlet covers 52 and flows into the upper air inlets 521, so that amounts of the cooling airflow flowing into the manifold sections 523 are relatively uniform. In this way, the door assemblies 53 (shown in FIG. 7) of the flow guiding cover assembly 5 of the first embodiment or the second embodiment may be omitted in the third embodiment, thereby reducing the manufacturing cost of the flow guiding cover assembly 5.

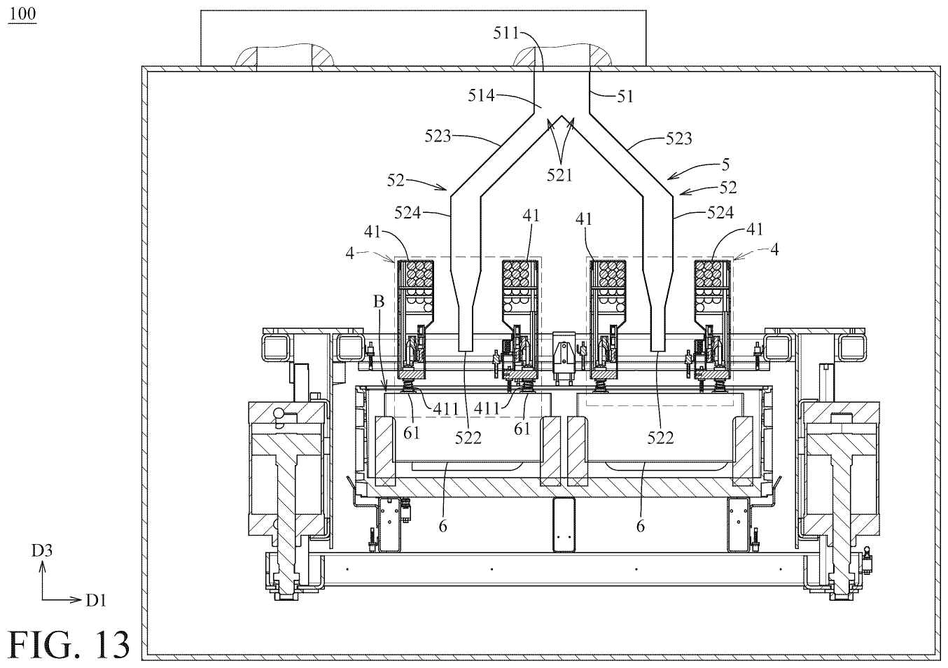

Referring to FIG. 13, a fourth embodiment of the battery formation equipment 100 according to the present disclosure is shown. The fourth embodiment is similar to the third embodiment, and the differences between the third embodiment and the fourth embodiment reside in the structure of the air outlet covers 52 of the flow guiding cover assembly 5.

For each of the air outlet covers 52, the lower air outlet 522 of the vertical section 524 is smaller than the upper air inlet 521 of the manifold section 523, such that a flow rate of the cooling airflow discharged from the lower air outlet 522 may be increased, and thus the cooling airflow may flow more quickly than that flows in the third embodiment to the top portion of the respective one of the battery packs (B) after being discharged via the lower air outlet 522.

In summary, by virtue of the structure that the air intake cover 51 is disposed at one side of the air conditioning device 2 to introduce the cooling airflow outputted by the air conditioning device 2, the cooling airflow and the air in the chamber 111 are not mixed, and thus the temperature of the cooling airflow in the flow guiding cover assembly 5 may be kept within a certain temperature range. Furthermore, by virtue of the structure that each of the air outlet covers 52 of the flow guiding cover assembly 5 is connected to the air intake cover 51, which causes direct discharge of the cooling airflow to the top portion of the respective one of the battery packs (B), heat dissipation performed by the cooling airflow on the battery packs (B) is relatively good. Moreover, since each of the air outlet covers 52 is disposed between the charge and discharge sets 41 of the respective one of the charge and discharge devices 4, the cooling airflow in the air outlet cover 52 does not pass the charge and discharge sets 41 and is not directly affected by the heat generated by the charge and discharge sets 41 before flowing out of the outlet cover 52. Thus, the cooling airflow may effectively dissipate heat of the battery packs (B) and heat dissipation performed by the battery formation equipment 100 of the present disclosure is relatively good.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A flow guiding cover assembly adapted to be disposed in a cabinet and between an air conditioning device and a carrier tray, the carrier tray carrying at least one battery pack, said flow guiding cover assembly comprising:
an air intake cover adapted to be disposed at one side of the air conditioning device, and provided for a cooling airflow outputted by the air conditioning device to flow therethrough; and
at least one air outlet cover connected to said air intake cover and adapted for discharging the cooling airflow to a top portion of the at least one battery pack.

2. The flow guiding cover assembly as claimed in claim 1, wherein said at least one air outlet cover is adapted to be disposed above said battery pack, and is formed with a lower air outlet facing downward, adapted to face the top portion of the at least one battery pack, and adapted for discharging the cooling airflow to the top portion of the at least one battery pack.

3. The flow guiding cover assembly as claimed in claim 2, wherein said lower air outlet is elongated in a horizontal direction, and the at least one battery pack extends in the horizontal direction.

4. The flow guiding cover assembly as claimed in claim 2, wherein:
said at least one air outlet cover is further formed with an upper air inlet in fluid communication with said air intake cover, and disposed above said lower air outlet; and
said lower air outlet has a size smaller than a size of said upper air inlet.

5. The flow guiding cover assembly as claimed in claim 1, wherein said air intake cover is formed with an air intake port that is adapted to be in fluid communication with the air conditioning device and provided for the cooling airflow to flow therethrough.

6. The flow guiding cover assembly as claimed in claim 1, the carrier tray carrying a plurality of battery packs that are arranged to be spaced apart from each other, wherein:
said at least one air outlet cover includes a plurality of air outlet covers connected to said air intake cover; and
each of said plurality of air outlet covers is adapted to be disposed above a respective one of the plurality of battery packs for discharging the cooling airflow to the top portion of the respective one of the plurality of battery packs.

7. The flow guiding cover assembly as claimed in claim 1, wherein:
said air intake cover is flat in shape, extends in a first horizontal direction, and is formed with an air intake port adapted to be in fluid communication with the air conditioning device and provided for the cooling airflow to flow therethrough;
said air intake cover has
an end wall opposite to and spaced apart from said air intake port in the first horizontal direction, and
a base wall disposed between said air intake port and said end wall, and being formed with at least one exhaust port; and
said at least one air outlet cover is upright, extends in a vertical direction perpendicular to the first horizontal direction, is disposed on said base wall, and is formed with
an upper air inlet in fluid communication with said at least one exhaust port, and
a lower air outlet disposed under said upper air inlet, facing downward, and adapted to face the top portion of the at least one battery pack for discharging the cooling airflow to the top portion of the at least one battery pack.

8. The flow guiding cover assembly as claimed in claim 7, the carrier tray carrying a plurality of battery packs that are arranged to be spaced apart from each other in the first horizontal direction, wherein:
said at least one exhaust port includes a plurality of exhaust ports spaced apart from each other in the first horizontal direction;
said at least one air outlet cover includes a plurality of air outlet covers disposed on said base wall and spaced apart from each other in the first horizontal direction;
each of said plurality of air outlet covers is adapted to be disposed above a respective one of the plurality of battery packs for discharging the cooling airflow to the top portion of the respective one of the plurality of battery packs; and
said upper air inlet of each of said plurality of air outlet covers is in fluid communication with a respective one of said plurality of exhaust ports.

9. The flow guiding cover assembly as claimed in claim 8, further comprising a plurality of said door assemblies, each of said plurality of door assemblies including a gate disposed in said air intake cover and operable to cover at least a portion of a respective one of said plurality of exhaust ports, such that a covering degree of said gate of each of said plurality of door assemblies covering the respective one of said plurality of exhaust ports is adjusted, and an opening size of the respective one of said plurality of exhaust ports is in negative correlation with the covering degree.

10. The flow guiding cover assembly as claimed in claim 9, wherein the covering degrees of said gates of said plurality of door assemblies gradually decrease from said end wall toward said air intake port, and the opening sizes of said plurality of exhaust ports gradually increase from said end wall toward said air intake port such that amounts of the cooling airflow respectively flowing through said plurality of exhaust ports gradually decrease from said air intake port toward said end wall.

11. The flow guiding cover assembly as claimed in claim 9, wherein:
said base wall is further formed with a plurality of pairs of elongated guide grooves that are respectively proximate to said plurality of exhaust ports;
said elongated guide grooves of each pair of said plurality of pairs of elongated guide grooves are spaced apart from each other in a second horizontal direction perpendicular to the first horizontal direction, each of said elongated guide grooves being elongated in the first horizontal direction;
each of said plurality of door assemblies further includes two adjustment screws respectively extending through and movable along said elongated guide grooves of a respective one pair of said plurality of pairs of elongated guide grooves,
for each of said plurality of door assemblies, said adjustment screws are threadedly connected to said gate, detachably fasten said gate to said base wall, and are operable to drive said gate to move relative to said base wall through movement of said adjustment screws respectively along said elongated guide grooves of the respective one pair of said plurality of pairs of elongated guide grooves when said gate is detached from said base wall.

12. The flow guiding cover assembly as claimed in claim 1, wherein:
said air intake cover is upright, and is formed with
an air intake port facing upward, and adapted to be in fluid communication with the air conditioning device and provided for the cooling airflow to flow therethrough, and
an exhaust port spaced apart from and disposed under said air intake port; and
said at least one air outlet cover is formed with
an upper air inlet communicating with said exhaust port, and
a lower air outlet disposed under said upper air inlet, facing downwardly, and adapted to face the top portion of the at least one battery pack for discharging the cooling airflow to the top portion of the at least one battery pack.

13. The flow guiding cover assembly as claimed in claim 12, the carrier tray carrying a plurality of battery packs that are arranged to be spaced apart from each other, wherein:
said at least one air outlet cover includes a plurality of air outlet covers;
each of said plurality of air outlet covers has
a manifold section connected to a bottom portion of said air intake cover and having said upper air inlet, and
a vertical section connected to a bottom portion of said manifold section and having said lower air outlet;
said manifold sections of said plurality of air outlet covers are connected to each other;
said exhaust port is in fluid communication equally with said upper air inlets of said manifold sections of said plurality of air outlet covers; and
said vertical sections of said plurality of air outlet covers are spaced apart from each other, and are adapted to be disposed above a respective one of the plurality of battery packs.

14. A battery formation equipment comprising:
a cabinet;
an air conditioning device disposed at an outer side of said cabinet;
a carrier tray disposed in said cabinet and adapted to carry at least one battery pack;
at least one charge and discharge device disposed in said cabinet and above said carrier tray, said at least one charge and discharge device including two charge and discharge sets that are spaced-apart from each other and that are adapted to be electrically connected to the at least one battery pack; and
said flow guiding cover assembly as claimed in claim 1, said at least one air outlet cover of said flow guiding cover assembly being disposed between said charge and discharge sets.

15. A battery formation equipment comprising:
a cabinet;
an air conditioning device disposed at an outer side of said cabinet;
a carrier tray disposed in said cabinet and adapted to carry a plurality of battery packs that are spaced apart from each other;
a plurality of charge and discharge devices disposed in said cabinet and above said carrier tray, each of said plurality of charge and discharge devices including two charge and discharge sets that are spaced-apart from each other and that are adapted to be electrically connected to a respective one of the plurality of battery packs; and
a flow guiding cover assembly disposed in said cabinet and between said air conditioning device and said carrier tray, and including
an air intake cover that is disposed at one side of said air conditioning device and that is provided for a cooling airflow outputted by said air conditioning device to flow therethrough, and
a plurality of air outlet covers that are connected to said air intake cover, each of said plurality of air outlet covers being disposed between said charge and discharge sets of a respective one of said plurality of charge and discharge device, and adapted to be disposed above a respective one of the plurality of battery packs for discharging the cooling airflow to a top portion of the respective one of the plurality of battery packs.
